(19) United States
(12) Patent Application Publication
(10) Pub. No.: US 2004/0005922 A1
(43) Pub. Date: Jan. 8, 2004

(54) Universal serial bus game machine

(76) Inventor: Robert A. Lewandowski, Webster, NY (US)

Correspondence Address: Robert J. Bird, 86 French Road, Rochester, NY, 14618, US

(21) Appl. No.: 10/612,213

(22) Filed: Jul. 3, 2003

Related U.S. Application Data
(60) Provisional application No. 60/393,760, filed on Jul. 8, 2002.

(51) Int. Cl. A63F 13/00

(52) U.S. Cl. 463/29; 463/25

(57) ABSTRACT

A universal serial bus (USB) game machine, for removable connection to a personal computer (PC) through a universal serial bus (USB) port of the computer, enables the game machine to operate with PC software on the computer, and enables games on PC software to interact with input/output functions of the game machine. The game machine includes: a controller chip for connection to the USB port to process input and output functions to and from the computer; an input function transmitter connected to the controller chip to transmit input functions to the controller chip; and an output function receiver connected to the controller chip to receive output functions from the controller chip.

### CROSS-REFERENCE TO RELATED APPLICATION

This application relates to my copending Provisional Patent Applicaton No. 60/393,760 which was filed on Jul. 8, 2002. That filing date is claimed for this application.

### BACKGROUND OF THE INVENTION

This invention is a computer gaming system, and more specifically a peripheral system for removable coupling with a personal computer. The Universal Serial Bus (USB) game machine of this invention adds real casino play action to PC games. The USB port connection on a PC allows my USB game machine to operate with PC software, local or web-based. Slot machine games, along with other PC game software, can be modified with my USB game machine drivers, allowing PC software to read coin input counts to run games, and coin output for game machine payouts. The USB game machine switches and lights can be operated by PC software for additional input and output controls. The USB hub connections in the game machine allow addition of a USB magnetic insertion reader. Dual and triple track versions of the insertion reader can read ANSI/ISO format cards, including credit/debit cards and drivers licenses, adding additional Input/Output for gaming. Adding a USB bill reader to the internal hub allows the game machine to read currency.

U.S. Pat. No. 6,251,014, issued Jun. 26, 20012 to Stockdale et al is the most relevant prior art that I know of. Stockdale discloses a gaming machine with a plurality of “gaming peripherals” each communicating with a master controller via a standard peripheral interface such as the Universal Serial Bus (USB). The gaming peripherals employ a standard peripheral controller and one or more specialized “peripheral devices” (e.g. lights, bill validators, ticket printers) that perform specific functions of the gaming peripherals. Much of the hardware associated with the peripheral controller is identical from one gaming peripheral to the next. Only a portion of the peripheral controller hardware is specific to the different types of gaming peripherals.

### SUMMARY OF THE INVENTION

In summary, this invention is a universal serial bus (USB) game machine for removable connection to a personal computer (PC) through a universal serial bus (USB) port of the computer, enabling the game machine to operate with PC software on the computer, and enabling games on PC software to interact with input/output functions of the game machine. The game machine includes: a controller chip for connection to the USB port to process input and output functions to and from the computer; an input function transmitter connected to the controller chip to transmit input functions to the controller chip; and an output function receiver connected to the controller chip to receive output functions from the controller chip.

### BRIEF DESCRIPTION OF DRAWINGS

In the accompanying drawing:

FIG. 1 is a schematic diagram of my USB Game Machine.

FIG. 2 is a Logic Block Diagram of the USB Game Machine's peripheral controller chip.

FIG. 3 is a Logic Block Diagram of digital I/O connections from the peripheral controller chip of FIG. 2.

### DETAILED DESCRIPTION

This invention relates to adding an external Universal Serial Bus (USB) game machine box to a Personal Computer (PC). The game machine will be controlled by PC software, local or web-based. The use of USB ports on virtually all PC's made today allows for easy connection to a PC.

USB was developed as a standardized, miniature, inexpensive interface for connecting peripheral devices to a PC at two speeds, high 12 MBPS (USB 2.0), and low 1.5 MBPS (USB 1.0). Compatibility exists between high and low speed connections. The USB bus can be hot switch allowing the interface to be connected or removed while the PC is running. The USB standard supports the use of a hub. Hubs are used to connect several devices to a single host USB port, with a maximum of 127 devices. The USB comprises four lines: power (+V); ground (GND); data (D+); and data (D−). The power and ground lines provide power from the host to the USB peripheral devices. The two data lines support bidirectional communications (half duplex) between the host computer and the USB peripheral device. Data is transferred bi-directionally in message packets. Most USB peripheral devices use an embedded microprocessor controller chip to handle serial protocol, physical link, and Inputs/Outputs (I/O). An embedded controller chip requires firmware to operate. Firmware on an embedded system controller can be downloaded on the USB for changes in software control.

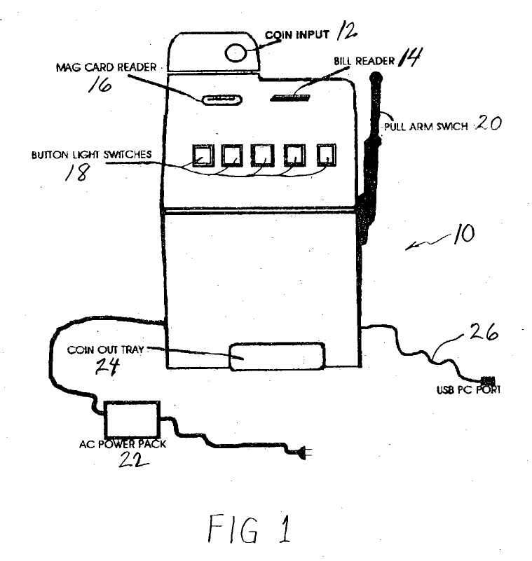

In the drawing, FIG. 1 shows my USB game machine 10 packaged as an old-style slot machine. It includes coin/token input 12, bill reader 14, magnetic card reader 16, button lamp switches 18, pull down arm switch 20, AC power supply 22, coin/token output tray 24, and a USB cable 26.

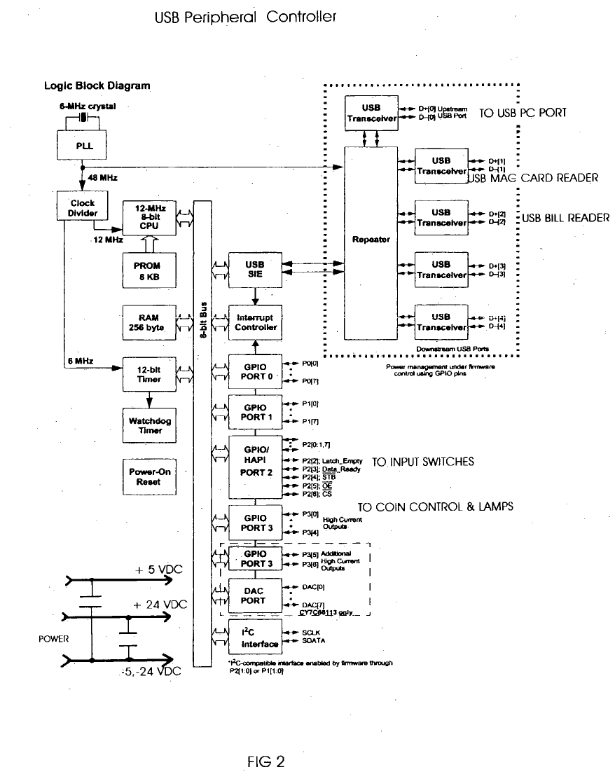

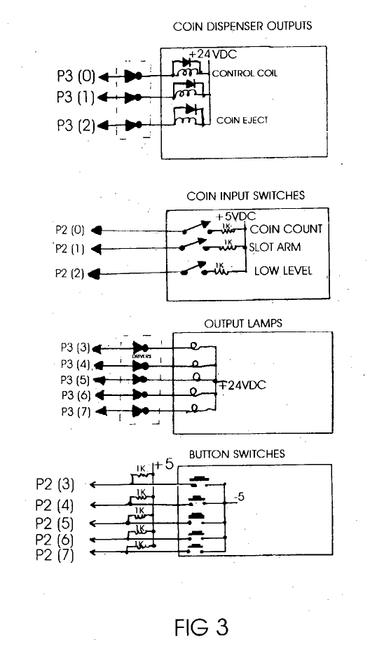

My USB game machine 10 also includes an embedded system USB peripheral controller chip (FIG. 2). The peripheral controller chip's CPU handles all USB communication and peripheral Input/Output (I/O) signals. The peripheral controller has four digital 8-bit I/O ports: P0; P1; P2; P3. Each bit on a port controls one digital I/O line (FIG. 3).

As seen in FIG. 3, Port P3 controls digital output signals (three coin/token coils; five display lamps). A higher current driver circuit is needed for the eight digital output lines connected to port P3. Port P2 is used for digital input signals (two coin/token count switches; five button switches; one pull down arm switch).

Switch bouncing is handled in software. The game machine peripheral controller chip includes an embedded USB hub repeater. Hubs on the control chip will allow the game machine to connect to a USB bill reader and USB magnetic card reader. A triple track version of the magnetic reader reads credit/debit cards and drivers' licenses. AC power pack provides 5 and 24 volt DC for game machine circuits.

The foregoing description provides an example of a preferred embodiment of this invention. The concept and scope of the invention are limited not by the description but only by the following claims and equivalents thereof.

What is claimed is:

1. A universal serial bus (USB) game machine for removable connection to a personal computer (PC) through a universal serial bus (USB) port of said computer, to enable said game machine to operate with PC software on said computer and to enable games on said PC software to interact with input/output functions of said game machine, said game machine including:
a controller chip for connection to said USB port to process input functions to said computer and output functions from said computer;
an input function transmitter operatively connected to said controller chip to transmit input functions to said controller chip; and
an output function receiver operatively connected to said controller chip to receive output functions from said controller chip.

2. A game machine as defined in claim 1, said input function transmitter including a coin/token input sensing device.

3. A game machine as defined in claim 1, said input function transmitter including a front panel button control switch.

4. A game machine as defined in claim 1, said input function transmitter including a pull-down arm run switch.

5. A game machine as defined in claim 1, said input function transmitter including a magnetic card reading device.

6. A game machine as defined in claim 1, said output function receiver including a coin-dispensing driver.

7. A game machine as defined in claim 1, said output function receiver including button on-off lights.

8. A game machine as defined in claim 1, said output function receiver including magnetic card data storage.

9. A universal serial bus (USB) game machine for removable connection to a personal computer (PC) through a universal serial bus (USB) port of said computer, said game machine including:
a controller chip for connection to said USB port to process input functions to said computer and output functions from said computer;
an input function transmitter operatively connected to said controller chip to transmit input functions to said controller chip; and
an output function receiver operatively connected to said controller chip to receive output functions from said controller chip;
whereby said game machine is enabled to operate with PC software on said computer, and games on said PC software are enabled to interact with input/output functions of said game machine.

10. A game machine as defined in claim 9, said input function transmitter including a coin/token input sensing device.

11. A game machine as defined in claim 9, said input function transmitter including a front panel button control switch.

12. A game machine as defined in claim 9, said input function transmitter including a pull-down arm run switch.

13. A game machine as defined in claim 9, said input function transmitter including a magnetic card reading device.

14. A game machine as defined in claim 9, said output function receiver including a coin-dispensing driver.

15. A game machine as defined in claim 9, said output function receiver including button on-off lights.

16. A game machine as defined in claim 9, said output function receiver including magnetic card data storage.
